(19) United States
(12) Patent Application Publication
(10) Pub. No.: US 2013/0204710 A1
(43) Pub. Date: Aug. 8, 2013

(54) SEQUENCING DISPLAY ITEMS IN A SOCIAL NETWORKING SYSTEM

(71) Applicants: Brian Thomas Boland, Los Altos, CA (US); Sean Michael Bruich, Palo Alto, CA (US)

(72) Inventors: Brian Thomas Boland, Los Altos, CA (US); Sean Michael Bruich, Palo Alto, CA (US)

(21) Appl. No.: 13/367,607

(22) Filed: Feb. 7, 2012

(51) Int. Cl. G06Q 30/02

(52) U.S. Cl. 705/14.66

(57) ABSTRACT

In one embodiment, the social networking selects a display item to display to a viewing user based on information about the viewing user and a display sequence tree associated with an ad campaign. The display items include advertisements, sponsored stories, and content objects created by users. The information about the user includes the viewing user's interactions, the viewing user's demographic information, and the viewing user's inferred characteristics. A display sequence tree associated with an ad campaign is a hierarchical arrangement of nodes that correspond to display items and represent possible sequences of display items. An ad campaign includes at least one request for a display item.

### BACKGROUND

This invention relates generally to social networking, and in particular to providing display items to users of a social networking system.

Conventional advertising systems may display a set of related advertisements to a user. For example, an ad campaign may have multiple advertisements for a product. In a social networking system, advertising may also take the form of sponsored stories, which display social content to a user based on actions performed by the user's friends in connection with the advertised brand on the social networking system. However, conventional advertising systems fail to manage the delivery of advertisements, sponsored stories, and other content items effectively and in a coordinated manner to improve the effectiveness of an ad campaign.

### SUMMARY

A social networking system sequences display items in a way that maximizes or otherwise increases the influence of the display items. The sequencing of display items may increase brand awareness, brand influence, brand attitude, ad recall, brand preference, friend awareness, intent, and favorability. For example, a sequence of display items may help a user remember a particular ad, remember the message of an ad, think more favorably of a company or brand, or be more likely to purchase a product. The sequencing of display items may also increase the likelihood that a user will view and/or interact with the display items. For example, a sponsored story may be displayed before an advertisement is displayed in order to increase the likelihood that a user will interact with the advertisement or another item that is subsequently displayed. In this example, the sponsored story, which displays information about a user's friends, helps bring attention to an advertiser's product or service thereby making the user more inclined to view and/or interact with a subsequently displayed advertisement. In this way, an advertiser improves the effectiveness of an ad campaign and a viewing user may discover new product, services, or promotions. A social networking system benefits by being able to provide a more customized user experience, and the resulting higher level of user interaction may lead to increased advertising revenue.

In one embodiment, the social networking selects a display item to display to a viewing user based on information about the viewing user and a display sequence tree associated with an ad campaign. The display items include advertisements, sponsored stories, and content objects created by users. The information about the user includes the viewing user's interactions, the viewing user's demographic information, and the viewing user's inferred characteristics. A display sequence tree associated with an ad campaign is a hierarchical arrangement of nodes that correspond to display items and represent possible sequences of display items. An ad campaign includes at least one request for a display item.

### BRIEF DESCRIPTION OF THE DRAWINGS

FIG. 1 is a high level block diagram illustrating a system environment suitable for sequencing display items, in accordance with one embodiment of the invention.

FIG. 2 is a high level block diagram illustrating a system environment, in accordance with one embodiment of the invention.

FIG. 3 is an example of a display sequence tree, in accordance with an embodiment of the invention.

FIG. 4 is a flow chart illustrating a process for sequencing display items, in accordance with an embodiment of the invention.

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

### DETAILED DESCRIPTION

### Overview

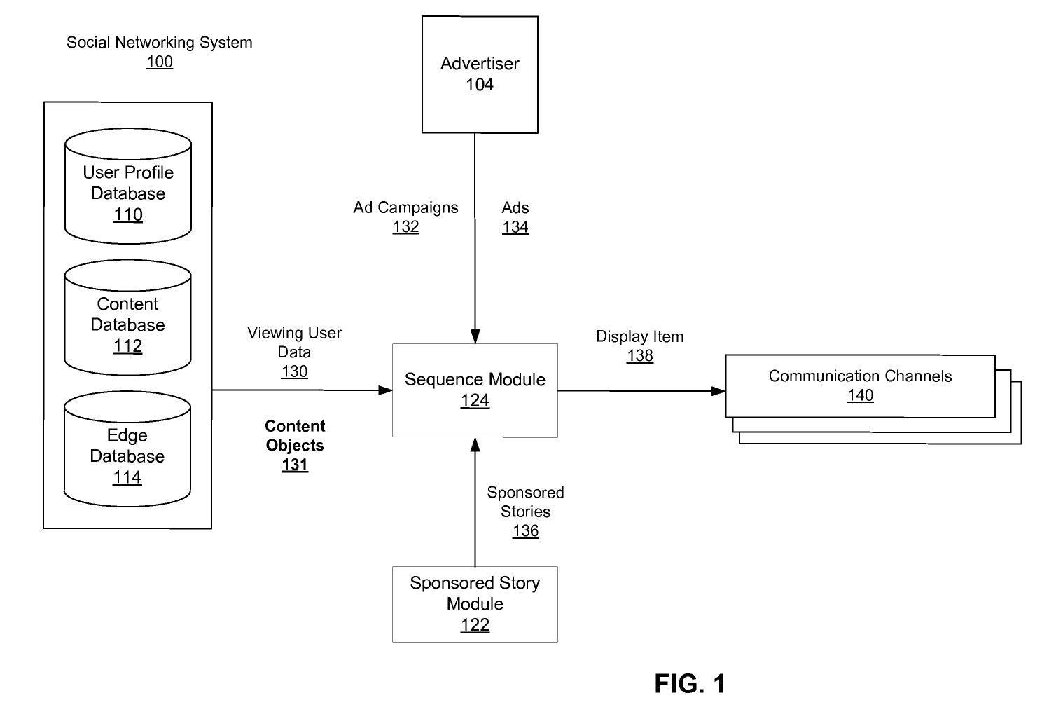

FIG. 1 is a high level block diagram of a process for sequencing display items to display to a user, in accordance with one embodiment. As illustrated in FIG. 1, the sequence module 124 receives viewing user data 130, display items 131, ad campaigns 132, advertisements 134, and sponsored stories 136. Using the viewing user data 130 for a viewing user, the sequence module 124 identifies an ad campaign, generates or retrieves a display sequence tree for the ad campaign, and selects a display item 138 in accordance with the display sequence tree and the viewing user data 130. The sequence module 124 sends the selected display item 138 to a user device via one or more communication channels 140.

The sequence module 124 retrieves the viewing user data 130 for a viewing user from the social graph 108. The viewing user data 130 may include user profile objects, edge objects and content objects. As used herein, the viewing user data 130 may also be referred to as profile information. User profile objects include declarative profile information about the viewing user. Edge objects connect objects in the social graph and include information about the viewing user's interactions with other objects on the social networking system 100, such as clicking on a link shared with the viewing user, sharing photos with other users of the social networking system, posting a status update message on the social networking system 100, and other actions that may be performed on and off the social networking system 100. The edge objects may include information about the viewing user's interactions with display items. In some embodiments, the edge objects include a user's affinity scores towards objects and users in the social networking system 100. In one embodiment, affinity scores of users for an object may be determined by the social networking system 100 based on the user's interactions with the specified object over time. The affinity scores of users may be computed for various objects based on actions performed on those objects, such as sharing a link to the object, commenting on the object, installing the object, and the like, as further described in a related application, “Contextually Relevant Affinity Prediction in a Social Networking System,” U.S. patent application Ser. No. 12/978,265, filed on Dec. 23, 2010, which is hereby incorporated by reference. Content objects 131 include objects created by users of the social networking system 100, such as status updates that may be associated with photo objects, location objects, and other users, photos tagged by users to be associated with other objects in the social networking system 100, such as events, pages, and other users, and applications installed on the social networking system 100. In some embodiments, the content objects 131 are display items. In some embodiments, the content objects 131 are received from third-party applications or third-party applications separate from the social networking system 100.

An advertiser 104 is an entity that provides advertisements 134 and ad campaigns 132 to the sequence module 124. In one embodiment, an advertisement is a web-based ad that is displayed in the margins or other dedicated area of a website. The advertisements may include banners ads, floating ads, expanding ads, wallpaper ads, pop-up ads, pop-under ads, video ads, map ads, animations, email ads, and mobile ads. In some embodiments, each of the advertisements is associated with one or more objects of the social networking system 100.

The information for an ad campaign 132 may include targeting criteria, a bid amount, one or more requests for display items, duration information, and a display sequence tree. The one or more requests for display items may include requests for advertisements and requests for sponsored stories. The targeting criteria specify characteristics of users of the target audience of the ad campaign. The targeting criteria may include demographic characteristics such as age, gender, income, geographic location, education, religion, race, marital status, household size, employment status, and political party affiliation. In some embodiments, the targeting criteria include affinity coefficients threshold for interests. For example, the targeting criteria may specify an affinity coefficient threshold for an interests in coffee. The bid amount includes an amount of money an advertiser is willing to pay for each instance that a member clicks on or takes some other follow-on action with respect to an advertisement or sponsored story. The duration information specifies a period of time the display items of the ad campaign are available to users for display. For example, the duration may specify a starting time and an ending time. In some embodiments, the information for an ad campaign 132 specifies a goal of the ad campaign. The goal of an ad campaign may include brand lift, brand awareness, brand influence, brand attitude, ad recall, brand preference, friend awareness, intent, and favorability. In some embodiments, the goal of the ad campaign is to increase user interactions with the display items associated with the ad campaign. In some embodiments, the information for an ad campaign 132 includes a display sequence tree or a reference to a display sequence tree.

The sponsored story module 122 generates or retrieves sponsored stories 136 and sends the sponsored stories 136 or a reference to the sponsored stories to the sequencing module 124. A sponsored story comprises an advertising message that communicates a message about at least one user action. A sponsored story, for example, may inform a user that a friend (or a number of friends) of the user has purchased a particular item made by an advertiser, will attend an event sponsored by an advertiser, has added a connection to a profile for a business or other entity, or has performed some other action related to the brand being advertised. Other examples of actions that may be described in a sponsored story may include checking in at a location, purchasing a product or service, joining a group, attending an event, using a third party application, playing a game, or expressing an affinity towards an object in the online system. In some embodiments, a sponsored story communicates a message about the actions of some number of friends of a user. For example, a user may receive a message like “Three of your friends have joined the “Yale Alumni Network.” In some embodiments, a sponsored story includes an indication that a friend of the viewing user approves of a product or service associated with the ad or has otherwise interacted with an object associated therewith. For example, a sponsored story may include a testimonial from a friend or an indication that the friend is a fan of a product. A sponsored story may also be referred to as a social ad. Social ads are discussed further in U.S. patent application Ser. No. 12/193,702, filed Aug. 18, 2008, which is hereby incorporated by reference in its entirety.

The sequence module 124 identifies a viewing user, retrieves user data 130 for the viewing user, selects or identifies an ad campaign, retrieves or generates a display sequence tree for the ad campaign, selects a display item to display to the viewing user, and sends the selected display item to the viewing user. The viewing user may be identified by a user identifier that correlates to the user profile for the viewing user. The user identifier may be received when the user requests a page of the social networking system or opens a native application. In some embodiments, the sequence module 124 identifies an ad campaign and then identifies a user targeted by the ad campaign.

The sequence module 124 selects an ad campaign that has targeting criteria that matches the viewing user's profile information. In some embodiments, an ad campaign is selected based in part on if the viewing user's profile information indicates that the viewing user is a fan of the brand, product, or service associated with the ad campaign. In some embodiments, an ad campaign is selected based in part on if the viewing user's profile information indicates that the viewing user has an affinity coefficient above a threshold for the brand, product, or service associated with the ad campaign. In some embodiments, an ad campaign is selected based in part on if the viewing user's profile information indicates that the viewing user has an affinity coefficient above a threshold for a similar or related brand, product, or service of the ad campaign. In some embodiments, the sequence module 124 selects an ad campaign based in part on the expected value for the ad campaign. For example, the sequence module 124 may select a set of candidate ad campaigns, determine the expected value for each of the ad campaigns, and select the ad campaign with the highest expected value. The expected value for an ad campaign may be a function of a user's affinity for the content of the display items (which acts as a proxy for the likelihood of that user will click on the display items) of the ad campaign and the amount of money that the social networking system can expect to receive. In some cases the expected value for an ad campaign may be a function of the user's likelihood of clicking on a display item of the ad campaign based on other display items the user has clicked on in the past.

The sequence module 124 retrieves or generates a display sequence tree for an ad campaign and/or a viewing user. A display sequence tree defines one or more sequences of display items to display to a viewing user based on the viewing user's data. More specifically, a display sequence tree is a hierarchical arrangement of nodes that correspond to display items and represent possible sequences of display items. A branch of a display sequence tree having two or more nodes represents a possible sequence of display items. In some embodiments, the each node of sequence display tree includes information identifying one or more display items, selection criteria, and display criteria.

The information identifying one or more display item may include a reference to a display item or a request for a type of display item. In some embodiments, a plurality of nodes in a display sequence tree identify display items that are specified by an advertiser or correspond to an ad campaign. In some embodiments, a node includes a request for a sponsored story. In some embodiments, the request for a sponsored story includes information identifying one or more types of actions to describe in the sponsored story. In some embodiments, the request for a sponsored story identifies friends of the viewing user that will be identified in the sponsored story. For example, the request may identify friends of the viewing user for whom the viewing user has at least a minimum affinity score. In some embodiments, the request for a sponsored story identifies friends of the viewing user that belong to a different network of users than the viewing user.

The selection criteria of a node is used by the sequence module 124 in determining whether to select the node and/or the one or more display items associated with the node. The selection criteria may specify any combination of information associated with a viewing user. In some embodiments, the selection criteria for a node specifies an action by the user. In some embodiments, the selection criteria for a node specifies an action by the user with a previously displayed item. For example, the selection criteria for a node may specify that the node is selected when the viewing user interacts with the display item of the parent node of the node. In some embodiments, the selection criteria for a node may specify the type of content or page being viewed by the viewing user. For example, the selection criteria for a node may specify that the node is selected when the viewing user is viewing a newsfeed, news story, profile page, fan page, picture, or video. In some embodiments, the selection criteria for a node specifies demographic information. For example, the selection criteria for a node may specify that the node should be selected when the viewing user is from a certain geographic region. In some embodiments, the selection criteria for a node is in terms of a user's affinity for a brand, a similar brand, category of brand, or types of display items. For example, the selection criteria for a node may specify that the node should be selected when the viewing user has an affinity score for a brand above a threshold score.

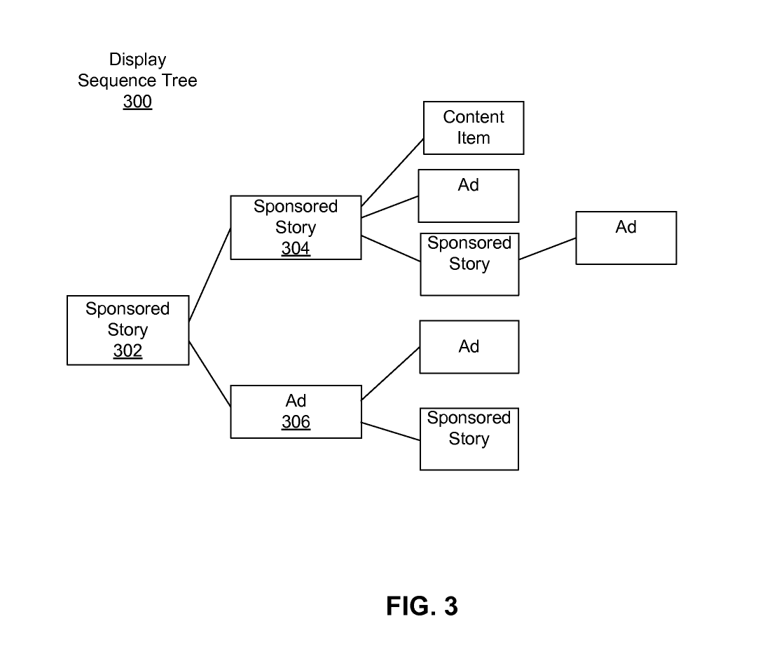

The display criteria of a node specifies how and when a display item associated with the node is display. For example, the display criteria may specify location and/or size of the display item. In some embodiments, the display criteria of a node specifies when each of the display items associated with the node are displayed. For example, a node may specify that its corresponding display item is displayed the next time a page is loaded, at a specific time in the future, or an amount of time after a previous display to the user of an item from the sequence. An example of a display sequence tree is discussed in more detail in the discussion of FIG. 3.

In some embodiments, the sequence module 124 generates a display sequence tree based on one or more factors including a viewing user's data, the goals of an advertiser, display templates for advertising goals, and historical data for individual display items. In some embodiments, the display sequence tree is based in part on a display template. A display template is a display sequence tree that is known to be effective for a particular purpose or goal. A display template may be based on past studies of displaying sequences of different types of display items. In some embodiments, the display templates may be specified by an advertiser. In The sequence module 124 may store a set of display templates and select a template for an ad campaign based on the goals of the ad campaign. For example, the sequence module 124 may store a table that correlates different templates to different campaign goals. For example, a display sequence may specify that a sponsored advertisement is displayed to a viewing user followed by either a sponsored story or an advertisement depending on the actions of the viewing user with respect the first displayed item. In some embodiments, a display template specifies particular display items that have been known to be effective in the past. For example, the display template may identifier a particular sponsored advertisement to display before a particular advertisement.

In some embodiments, the display sequence tree is based in part on the viewing user's profile information and/or the inferred characteristics of the viewing user. More specifically, the viewing user's profile information and/or the inferred characteristics may affect the proportion of different types of display items in the display sequence tree. Certain types of users may be more inclined to different types of display items. For example, the display sequence tree for male users may include a larger proportion of sponsored stories or news stories.

In some embodiments, the display sequence tree is based in part on the viewing user's interaction history. More specifically, the viewing user's interaction history may affect the proportion of different types of display items in the display sequence tree. For example, if the viewing user interacts with advertisements with a certain frequency, the display sequence may include a larger number of advertisements.

In some embodiments, a display sequence tree is based in part on the viewing user's interests or inferred interests. More specifically, the viewing user's interests or inferred interests may affect the proportion of different types of display items in the display sequence tree. For example, if the viewing user has affinity for a brand associated with an ad campaign below a certain threshold, the display sequence may include a larger proportion of sponsored stories.

The sequence module 124 selects a sequence of display items to display to a viewing user. For example, the sequence module 124 may determine an ordered sequence that includes a sponsored story, an advertisement, a news story, a message from an advertiser, and then an advertisement for an event.

The sequence module 124 selects a display item to display to a viewing user based on the display sequence tree and the viewing user's data 130. In particular, the sequence module 124 identifies the current node in the display sequence tree which corresponds to the most recently displayed item, identifies the child nodes of the current node, selects a child node based on the selection criteria of the child node and the view user's data, and retrieves a display items associated with the selected child node. In some embodiments, the sequence module 124 selects the child node having selection criteria that the viewing user's data satisfies or matches. For example, if the selection criteria of the child node specifies that the user should have an affinity for coffee above a threshold and the viewing user has an affinity for coffee above a threshold, the sequence module 124 selects the child node.

After a node is selected, the sequence module 124 identifies a particular display item associated with the node. In some embodiments, the node specifies a particular display item. In some embodiments, the node includes a request for a type of display item and the sequence module 124 selects a display item corresponding to the type. In some embodiments, the sequence module 124 selects a display item from a set of display items that are known to be effective. For example, the sequence module 124 may maintain a table of references to display items that have been successful for some goal such as inducing a user to interact with a subsequent display item. In some embodiments, the items in the set of display items are associated with a success metric that measures the effectiveness of the items in a display sequence. In some embodiments, the sequence module 124 selects a display item based on the viewing user's affinity for the display item. For example, the sequence module 124 may select the display item that the viewing user has the highest affinity coefficient for.

The sequence module 124 sends the selected display item 138 to a user device via one or more communication channels 140. The communication channels 140 may comprise one or more different information delivery methods, comprising a stream, a feed, a wall post, an email communication, a comment on a posted content item, a mobile application, a note, a third-party application, a text message, an iframe, a third-party website, a toolbar plug-in, a dashboard, a notification, an advertising communication channel, a discussion board, or any other communication channel that exists or is associated with the social networking service. A discussion board may reside on many different types of objects, such as an event, a group, a fan page, and a photo album, just to name a few. A display item may be sent to a user device via the communication channels 140. Communication channels are discussed further in U.S. patent application Ser. No. 12/253,149, filed on Oct. 16, 2008, which is hereby incorporated by reference in its entirety.

### Overview of Social Networking Systems

Online social networking systems comprise one or more computing devices storing a social network, or a social graph, comprising a plurality of users and providing users of the social networking system with the ability to communicate and interact with other users of the social networking system. Social networking systems allow users to explicitly associate themselves and establish connections with other users of the social networking system. When two users become connected, they are said to be “friends,” “contacts,” “connections,” or “associates” within the context of the social networking system. Alternatively, connections may be automatically created by the social networking system based on common characteristics of the users (for example, users who have had a common employer, have a common friend, or like a common film). Generally, being connected in a social networking system allows connected users access to more information about each other than would otherwise be available to unconnected users. Likewise, becoming connected within a social networking system may allow a user greater access to communicate with another user, such as by email (internal and external to the social networking system), instant message, text message, phone, or any other communicative interface. Finally, being connected may allow a user access to view, comment on, download or endorse another user's uploaded content items. Examples of content items include but are not limited to messages, queued messages (e.g., email), text and SMS (short message service) messages, comment messages, messages sent using any other suitable messaging technique, an HTTP link, HTML files, images, videos, audio clips, documents, document edits, calendar entries or events, other user-generated content, and other computer-related files.

Online social networking systems may track objects through the use of a social graph, which includes a plurality of nodes that are interconnected by a plurality of edges. In the social graph, nodes represent objects within the context of the social networking system. Common examples of objects include users, content items, groups, web pages, fan pages, events, messages, concepts, interactions, information, activities, data, computer applications, advertisements, or any other entity capable of being represented in a social networking system. Companies, locations, venues, merchants, bands, non-user persons, restaurants, or any other entities may be directly represented by a social networking system object, or may be indirectly represented by an object via a group, web page or fan page within the social networking system dedicated to the entity. For instance, the restaurant “Refuge” or the venue “Orpheum Theatre” may have dedicated objects within the social networking system; alternatively, Refuge may have a fan page and the Orpheum Theatre may have a web page on the social networking system.

An edge between nodes in the social graph represents a particular kind of connection between the two nodes, which may result from an interaction that occurred between the nodes. For instance, for two nodes that represent users, an edge may imply that the users are friends within the context of the social networking system. Alternatively, an edge may imply that the users have communicated with each other, that one user may have viewed the other's profile, that the users attended the same high school, or any other means of connection or interaction. For two nodes where at least one node does not represent a user, an edge may imply similar or different connections or interactions. For example, an edge may indicate a user clicked the “like” button for a group dedicated to a particular band, or that a user clicked on an advertisement. Alternatively, an edge may indicate that two companies, each represented by a social networking system web page, are associated with each other despite no explicit action by either company.

When a new object of a particular type is created, the social networking system may initialize a new node of the corresponding type, may assign a unique object or node identifier to it, and may begin to add data to the object as needed. This might occur, for example, when an individual first becomes a user of the social networking system, when the social networking system generates a new user profile, when a user starts a new group, when a new content item is uploaded to the social networking system, or any other time an object is added to or created within the social networking system. When a new object is created, an edge may be created linking the object node to the node representing the user who created the object. In addition, the social networking system may link the new object node or any existing nodes to other social graph nodes automatically. For instance, if a first user uploads a photograph of a sports bar to the social networking system, and afterwards, a fan page for the sports bar is created, the social networking system may provide an edge between the user node and the fan page node without explicit action by a user. Further, if a second user posts a comment about going to the sports bar on a third user's profile, the second user's and third user's nodes may be automatically connected to the sports bar node without explicit action by either user in regards to the sports bar node.

Users of social networking systems may interact with social networking system objects in a variety of forms, such as by communicating with or commenting on a content item, information or action; clicking a button or link associated with approval (such as a “like” button or the equivalent); sharing a content item, user information or user actions with other users; or downloading or merely viewing a content item. Interaction may also comprise using a computer-based application within the context of the social networking system (such as a video game only accessible and playable from within the social networking system), or an application external to the social networking system (such as a desk top web browser or mobile application) that may or may not interface with the social networking system. Further, interactions also include making a purchase, either in the context of the social networking system, or external to the social networking system; joining, commenting on or subscribing to a social networking system group, web page or fan page; using a mobile device to transmit a current or past location to the social networking system (“checking in” to a location); scheduling a meeting, gathering, errand, vacation, task, objective, reservation, date, or any other event or calendar entry; and accepting an invitation to or indicating the intent to attend a meeting, gathering, party, concert, play, or any other event. For instance, a user may join a group dedicated to Chopin, may buy tickets to a Chopin performance, may check into the concert hall when the user arrives at the performance, and may post a note to the user's profile reviewing the performance, all of which constitute interactions.

Users of social networking systems may also interact with other users by associating with, connecting to or becoming friends with them, by viewing their profile, by communicating with them, or by having common friends within the social networking system. In addition, a social networking system user may interact with content items, websites, other users, or other information outside of the context of the social networking system's web pages that are connected to or associated with the social networking system. For instance, an article on a news web site might have a “like” button that users of the social networking system can click on to express approval of the article. Likewise, a company's website may provide the ability to join a social networking system group dedicated to the company directly from the company's website. These interactions and any other suitable actions within the context of a social networking system may be recorded in social networking system data, which can be used to generate social endorsement information. The social endorsement information may comprise text, images, links, and/or be of any suitable form necessary to convey social endorsement information to a user.

### System Environment

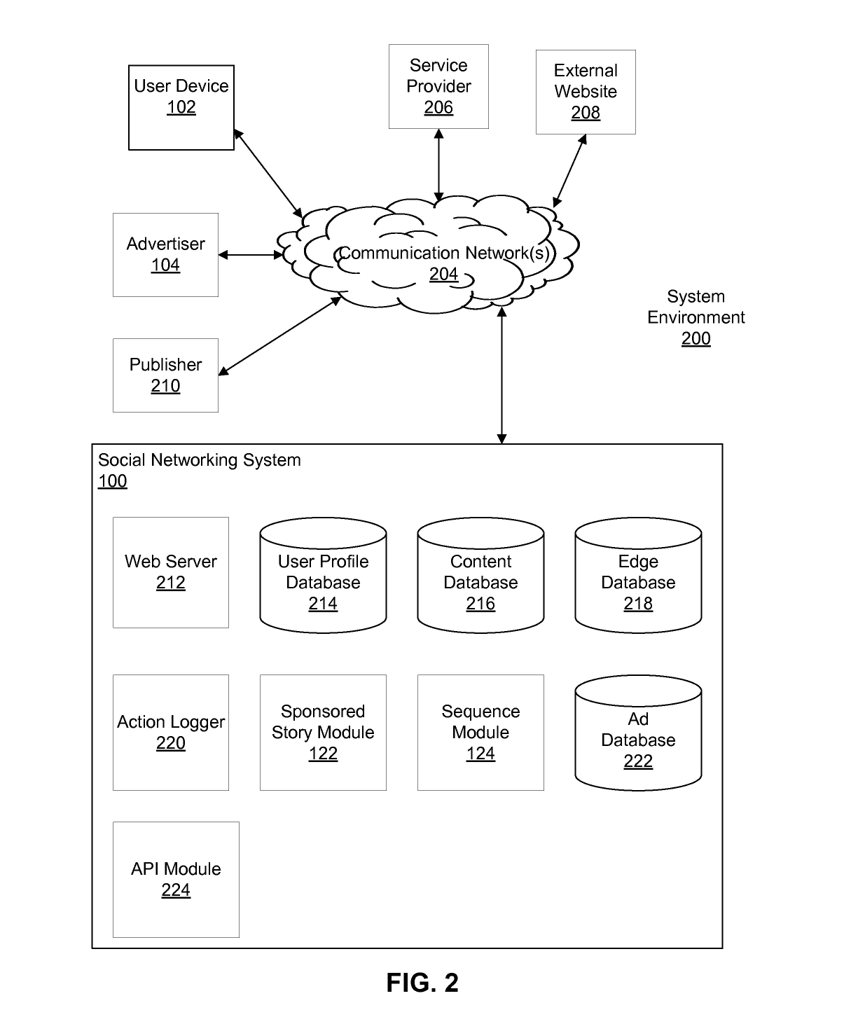

FIG. 2 is a high level block diagram illustrating a system environment 200, in accordance with one embodiment. The system environment 200 comprises one or more user devices 102, the social networking system 100, a network 204, one or more service providers 206, an advertiser 104, a publisher 210, and external websites 208. In alternative configurations, different and/or additional modules can be included in the system. In some embodiments, the social networking system 100 is implemented as a single server, while in other embodiments it is implemented as a distributed system of multiple servers. For convenience of explanation, the social networking system 100 is described below as being implemented on a single server system.

The communication network(s) 204 can be any wired or wireless local area network (LAN) and/or wide area network (WAN), such as an intranet, an extranet, or the Internet. It is sufficient that the communication network 204 provides communication capability between the user devices 102 and the social networking system 100. In some embodiments, the communication network 204 uses the HyperText Transport Protocol (HTTP) and the Transmission Control Protocol/Internet Protocol (TCP/IP) to transmit information between devices or systems. HTTP permits the user devices 102 to access various resources available via the communication network 204. The various embodiments of the invention, however, are not limited to the use of any particular protocol.

The user devices 102 comprise one or more computing devices that can receive user input and can transmit and receive data via the network 204. In one embodiment, the user device 102 is a conventional computer system executing, for example, a Microsoft Windows-compatible operating system (OS), Apple OS X, and/or a Linux distribution. In another embodiment, the user device 102 can be a device having computer functionality, such as a personal digital assistant (PDA), mobile telephone, smart-phone, etc. The user device 102 is configured to communicate via network 204. The user device 102 can execute an application, for example, a browser application that allows a user of the user device 102 to interact with the social networking system 100. In another embodiment, the user device 102 interacts with the social networking system 100 through an application programming interface (API) that runs on the native operating system of the user device 102, such as iOS and ANDROID.

A service provider 206 includes any entity that provides data or an online service to a user over a network, including but not limited to social networking systems, web retailers, news providers, video content item providers, etc. The embodiments disclosed herein may include one or more service providers 206.

A publisher 210 is an entity that sends display items a user device 102 for display to a viewing user. A publisher 210 may include, for example, a service provider 206 such as a newspaper, a video content provider, a web retailer, an email service provider, or a social networking system. In one embodiment, the publisher 210 receives an advertisement or sponsored story provided by the social networking system 100 and sends the advertisement or sponsored story to a user device 102 for display.

The web server 212 links the social networking system 100 via the network 204 to one or more user devices 102; the web server 212 serves web pages, as well as other web-related content, such as Java, Flash, XML, and so forth. The web server 212 may provide the functionality of receiving and routing messages between the social networking system 100 and the user devices 102, for example, instant messages, queued messages (e.g., email), text and SMS (short message service) messages, or messages sent using any other suitable messaging technique. The user can send a request to the web server 212 to upload information, for example, images or videos that are stored in the content database 216. Additionally, the web server 212 may provide API functionality to send data directly to native user device operating systems, such as iOS, ANDROID, webOS, and BlackBerry OS.

The action logger 220 is capable of receiving communications from the web server 212 about user actions on and/or off the social networking system 100. The action logger 220 populates an action log with information about user actions that users have given informed consent to collect. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communicate information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for users are stored as user profile objects in the user profile database 214. The user profile information stored in user profile database 214 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile database 214 also maintains references to the actions stored in an action log and performed on objects in the content database 216.

The edge database 218 stores the information describing connections between users and other objects on the social networking system 100 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge database 218 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge database 218, in one embodiment. For example, a user that plays multiple songs from Lady Gaga's album, “Born This Way,” may have multiple edge objects for the songs, but only one edge object for Lady Gaga.

The ad database 222 stores advertisements and ad campaigns. In some embodiments, each advertisement is associated with one or more objects. In some embodiments, the ad database 222 stores sponsored stories.

The Application Programming Interface (API) request server 224 allows one or more external websites 208 to access information from the social networking system 100 by calling one or more APIs. The API request server 224 may also allow external websites 208 to send information to social networking website by calling APIs. For example, an external website 208 sends an API request to the social networking system 100 via the network 204 and the API request server 224 receives the API request. The API request server 224 processes the request by calling an API associated with the API request to generate an appropriate response, which the API request server 224 communicates to the allow the external website 208 via the network 204. For example, responsive to an API request, the API request server 224 collects data associated with a user and communicates the collected data to the external websites 208.

### Display Sequence Tree Example

FIG. 3 illustrates a display sequence tree 300 used by the sequence module 124, in one embodiment. As shown in FIG. 3, the display sequence tree 300 is a hierarchical arrangement of nodes that correspond to display items. The branches of the display sequence tree 300 represent different possible sequences of display items.

The sequence module 124 may selects a sequence of display items to display to a viewing user based the display sequence tree 300 and the viewing user's data. Initially, the sequence module 124 identifies the root node 302, identifies the display item type associated with the root node, and selects a display item to display corresponding to the identified display item type (i.e., a sponsored story). In the example of FIG. 3, the nodes of the display sequence tree 300 specify display item types. As discussed above, in some embodiments, the nodes may specify specific display items. After displaying the display item of the type specified by the root node 302, the sequence module 124 selects a child node (e.g., node 304 or node 306) of the root node 302 based on selection criteria associated with the child nodes of the root node 302. More specifically, the sequence module 124 identifies the child nodes of the current node (i.e., the root node 302), retrieves the selection criteria of the child nodes, and selects a child node based on a matching of the viewing user's data and the selection criteria for the child node. As discussed above, the selection criteria for a node may specify any combination of information associated with a user. In one example, the selection criteria for the node 304 may specify that the node should be selected if the viewing user interacted with the previously displayed item. In this example, the sequence module 124 selects the node 304 if the viewing user interacted with the sponsored story corresponding to the root node 302. In another example, the selection criteria for node 305 may specify that the node should be selected if the viewing user did not interact with the previously displayed item and if the viewing user is viewing a profile page. After selecting the second display item of the sequence, the sequence module 124 selects a third display item to display based on the selection criteria of the child nodes of the node corresponding to the second display item. The sequence module 124 continues to use the display sequence tree 300 for the duration of the ad campaign. In some embodiments, an ad campaign ends when the sequence module 124 reaches a node of the display sequence tree 300 that does not have any child nodes.

### Sequencing Display Items

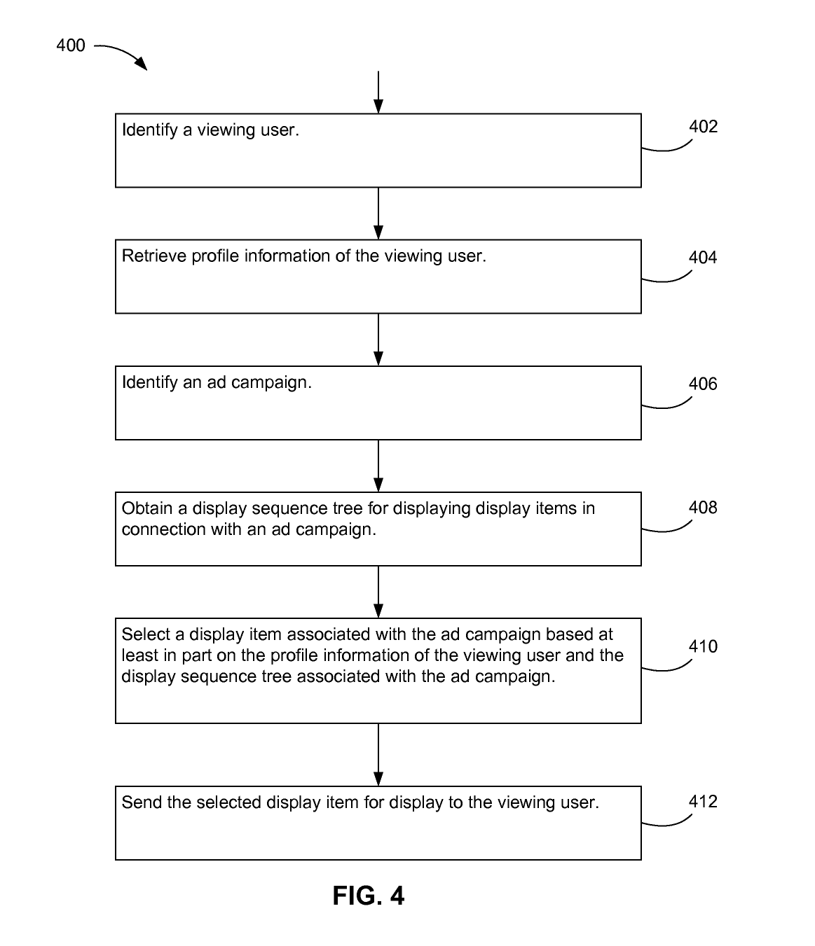

FIG. 4 is a flow chart of a process 400 for sequencing display items to display to a viewing user, in accordance with one embodiment. The process 400 is performed at a server system (e.g., social networking system 100) having one or more processors and non-transitory memory. The non-transitory memory stores one or more programs to be executed by the one or more processors. The one or more programs include instructions for process 400.

In this process 400, a viewing user of the social networking system is identified 402 and profile information is retrieved 404 for the viewing user. The profile information comprises viewing user data described above. An ad campaign is identified 406. The ad campaign comprises one or more requests for display items and includes targeting criteria matching the viewing user's profile information.

A display sequence tree for displaying display items in connection with the ad campaign is obtained 408. In some embodiments, the display sequence tree is specified by an advertiser corresponding to the ad campaign. In some embodiments, the display sequence tree is generated based in part on a display sequence tree template. In some embodiments, the display sequence tree is based in part on the viewing user's profile information.

A display item associated with the ad campaign is selected 408 based at least in part on the profile information of the viewing user and the display sequence tree associated with the ad campaign. In particular, the sequence module 124 identifies a current node in the sequence display tree, selects a child node of the current node based on a matching of the viewing user's profile information and selection criteria associated the child node, and retrieves a display item associated to the selected child node.

The selected display item is sent 410 to the viewing user for display. In some embodiments, the display item is displayed in accordance with display criteria associated with the node in the display sequence tree corresponding to the display item. In some embodiments, the selected display item is sent responsive to a request for a page of the social networking system. In some embodiments, the selected display item is sent at a predefined time. In some embodiments, the selected display item is sent a predefined amount of time after a previous display item was sent.

In some embodiments, a second display item is selected to display to the viewing user. The selecting includes identifying a node in the display sequence tree corresponding to the mostly recently displayed item, identifying one or more child nodes of the node, retrieving selection criteria associated with the one or more child nodes, selecting a child node from the one or more child nodes based on the selection criteria associated with the child node and profile information for the viewing user, retrieving a display item associated with the child node, and sending the retrieved display item associated with the child node for display to the viewing user.

### SUMMARY

The foregoing description of the embodiments of the invention has been presented for the purpose of illustration; it is not intended to be exhaustive or to limit the systems and methods to the precise forms disclosed. Persons skilled in the relevant art can appreciate that many modifications and variations are possible in light of the above disclosure.

Some portions of this description describe the embodiments of the systems and methods in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the systems and methods may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the systems and methods may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the systems and methods systems and methods be limited not by this detailed description, but rather by any claims that issue on an application based hereon. Accordingly, the disclosure of the embodiments of the systems and methods are intended to be illustrative, but not limiting, of the scope of the invention, which is set forth in the following claims.

1. A method comprising:
maintaining an ad campaign in a data store, the an ad campaign comprising one or more requests for display items;
obtaining a display sequence tree for displaying the display items to an individual user in connection with the ad campaign;
identifying a viewing user of a social networking system;
retrieving profile information for the viewing user;
selecting a first display item based at least in part on the profile information for the viewing user and the display sequence tree associated with the ad campaign; and
sending the first display item for display to the viewing user.

2. The method of claim 1, wherein a display item is selected from the group consisting of advertisements, sponsored stories, news stories, photos, videos, status updates, comments, or any combination thereof.

3. The method of claim 2, wherein a sponsored story comprises a message that a connection of the viewing user has performed an action within the social networking system.

4. The method of claim 1, wherein the display sequence tree comprises a hierarchical arrangement of nodes that correspond to display items and wherein branches of the display sequence tree having two or more nodes correspond to possible sequences of display items.

5. The method of claim 4, wherein the selecting comprises identifying a node in the display sequence tree and wherein the first display item is associated with the identified node.

6. The method of claim 4, wherein a plurality of nodes of the display sequence tree include information identify one or more types of display items.

7. The method of claim 4, wherein a plurality of nodes of the display sequence tree include one or more references to display items.

8. The method of claim 4, wherein a plurality of nodes of the display sequence tree include display criteria.

9. The method of claim 1, wherein the profile information includes a viewing history of the viewing user with display items associated with the ad campaign.

10. The method of claim 1, wherein the profile information includes demographic information of the viewing user.

11. The method of claim 1, wherein the display sequence tree is defined by an advertiser associated with the ad campaign.

12. The method of claim 1, wherein the display sequence tree is determined based on a display sequence tree template.

13. The method of claim 1, wherein display sequence tree is determined based on the profile information for the viewing user.

14. The method of claim 1, wherein the first display item is sent responsive to a request for a page of the social networking system.

15. The method of claim 1, wherein the first display item is sent at a predefined time.

16. The method of claim 1, wherein the first display item is sent at a predefined amount of time after a previous display item was sent.

17. The method of claim 1, further comprising:
identifying a node in the display sequence tree corresponding to the first display item;
identifying one or more child nodes of the node;
retrieving selection criteria associated with the one or more child nodes;
selected a child node from the one or more child nodes based on the selection criteria associated with the child node and profile information for the viewing user;
retrieving a display item associated with the child node; and
sending the retrieved display item associated with the child node for display to the viewing user.

18. A non-transitory computer readable storage medium storing one or more programs configured to be executed by a server system, the one or more programs comprising instructions for:
maintaining an ad campaign in a data store, the an ad campaign comprising one or more requests for display items;
obtaining a display sequence tree for displaying the display items to an individual user in connection with the ad campaign;
identifying a viewing user of a social networking system;
retrieving profile information for the viewing user;
selecting a first display item based at least in part on the profile information for the viewing user and the display sequence tree associated with the ad campaign; and
sending the first display item for display to the viewing user.

19. A method comprising:
maintaining an ad campaign in a data store, the an ad campaign comprising one or more requests for an advertisement and one or more requests for a sponsored story, wherein a sponsored story comprises a message that a connection of a user viewing the sponsored story has performed an action within a social networking system;
obtaining a display sequence tree for displaying the advertisements and sponsored stories to an individual user in connection with the ad campaign;
identifying a viewing user of the social networking system;
retrieving profile information for the viewing user, the profile information comprising a viewing history of any previous views by the viewing user of the advertisements and sponsored stories associated with the ad campaign;
selecting a first display item, the first display item comprising one of an advertisement or a sponsored story associated with the ad campaign for display to the viewing user, the selecting based at least in part on the viewing history of the viewing user and the display sequence tree associated with the ad campaign; and
sending the selected first display item for display to the viewing user.

20. The method of claim 17, further comprising:
selecting a second display item, the second display item comprising one of an advertisement or a sponsored story associated with the ad campaign for display to the viewing user, the selecting based at least in part on whether the viewing user interacted with the first display item and the display sequence tree associated with the ad campaign; and
sending the selected second display item for display to the viewing user.
